(19) United States
(12) Patent Application Publication
(10) Pub. No.: US 2010/0218185 A1
(43) Pub. Date: Aug. 26, 2010

(54) Implementation of a User-Controlled Transactional Resource

(76) Inventor: Vladimir Angelov Ralev, Bourgas (BG)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/392,829

(22) Filed: Feb. 25, 2009

(51) Int. Cl. G06F 9/46

(52) U.S. Cl. 718/100

(57) ABSTRACT

In one embodiment, a mechanism for implementation of a user as a transactional resource in a telecommunications platform is disclosed. In one embodiment, a method includes initiating a transaction as part of a transactional application in a transaction processing architecture, performing one or more transaction operations as part of the transaction on one or more transactional resources of the transaction processing architecture, contacting a user of the transactional application as one of the transaction operations performed on a user-controlled transactional resource, and storing a result of contacting the user in at least one of the user-controlled transactional resource or a transaction manager overseeing the transaction.

### TECHNICAL FIELD

The embodiments of the invention relate generally to transaction processing platforms and, more specifically, relate to implementation of a user-controlled transactional resource.

### BACKGROUND

In computer science, transaction processing is information processing that is divided into individual, indivisible operations, called transactions. Each transaction must succeed or fail as a complete unit; it cannot remain in an intermediate state. Transaction processing is designed to maintain a computer system in a known, consistent state, by ensuring that any operations carried out on the system that are interdependent are either all completed successfully or all canceled successfully.

To emulate a business transaction, a program may need to perform several steps. A financial program, for example, might transfer funds from a checking to a savings account using the steps listed in the following pseudocode:

```
begin transaction
    debit checking account
    credit savings account
    update history log
commit transaction
```

Either all of these steps must be complete, or none of them at all. Otherwise, data integrity is lost. A transaction can end in two ways: with a commit or a rollback. When a transaction commits, the data modifications made by its statements are saved. If a statement within a transaction fails, the transaction rolls back, undoing the effects of all statements in the transaction. In the pseudocode above, for example, if a disk drive were to crash during the credit step, the transaction would rollback and undo the data modifications made by the debit step. Although the transaction fails, data integrity would be intact because the accounts still balance.

One way to provide additional security in current business methods used in transactional processing is to provide confirmation of the transaction from a user of its business method, which allows the business method to succeed or fail. For example, in the above financial transaction, an owner of the accounts (i.e., a user) could be contacted to confirm, approve, or reject the funds transfer. However, in this context, the user is not a transactional resource and any methods to contact the user for confirmation or approval have to be performed manually outside of the transaction context. If a user does approve or reject the transaction, then this must be communicated manually to the transaction context in order for the transaction to commit or rollback. Additionally, if some other part of the transaction fails the user must be notified of the failure even if the user has previously confirmed the operation. This notification would be the rollback operation of the user transactional resource. Unfortunately, implementing this behavior manually is not an efficient mechanism to add further security to a transaction.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of a general transaction processing architecture implementing user-controlled transactional resources according to an embodiment of the invention;

FIG. 2 is a block diagram of a JAVA Transaction Service (JTS) architecture implementing user-controlled transactional resources according to an embodiment of the invention;

FIG. 3 is a flow diagram illustrating a method for using a user-controlled transactional resource as part of a transaction processing context according to an embodiment of the invention;

FIG. 4 is a flow diagram illustrating a method for implementing a user-controlled transactional resource in a JAVA environment according to an embodiment of the invention; and

FIG. 5 illustrates a block diagram of one embodiment of a computer system.

### DETAILED DESCRIPTION

Embodiments of the invention provide for implementation of a user-controlled transactional resource. In one embodiment, a method of implementing a user-controlled transactional resource includes initiating a transaction as part of a transactional application in a transaction processing architecture, performing one or more transaction operations as part of the transaction on one or more transactional resources of the transaction processing architecture, contacting a user of the transactional application as one of the transaction operations performed on a user-controlled transactional resource, and storing a result of contacting the user in at least one of the user-controlled transactional resource or a transaction manager overseeing the transaction.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “attaching”, “forwarding”, “caching”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

Embodiments of the invention provide for a user-controlled transactional resource. The user-controlled transactional resource represents a result of contacting a user for confirmation or approval of the transaction. By utilizing a user-controlled transactional resource, the user is part of the transaction and, as such, is a required component to commit or rollback the transaction. Embodiments of the invention are useful in the automation of confirming a transaction and cleaning up the state of the transaction via rollback or commit. Otherwise, manual work is required to involve the user. In addition, embodiments of the invention add security to transactions in an efficient manner.

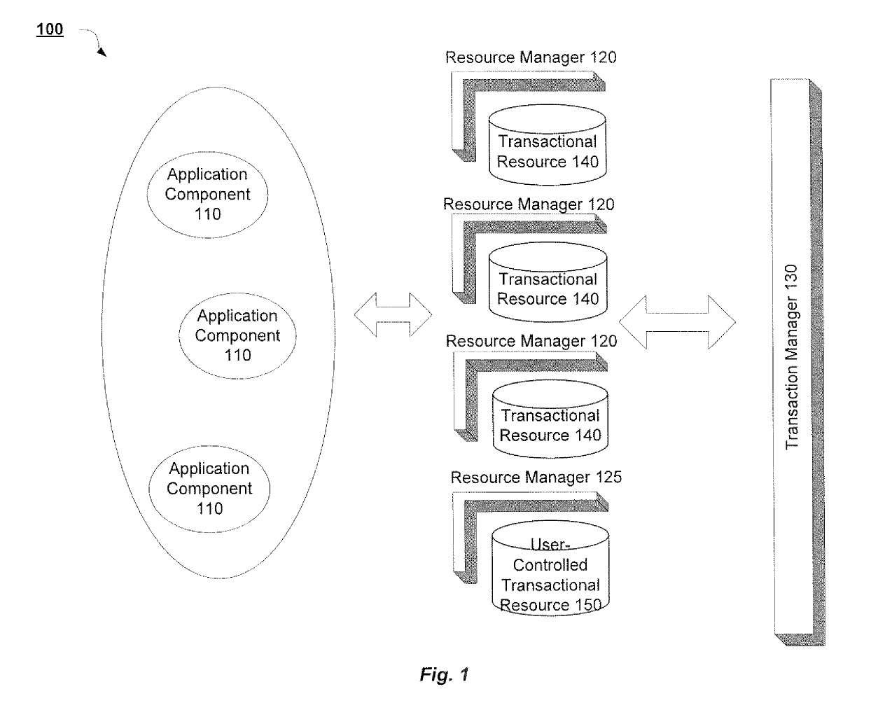

FIG. 1 is a block diagram of a general transaction processing architecture 100 implementing user-controlled transactional resources according to an embodiment of the invention. This transaction processing architecture 100 introduces a transaction manager 130 and a resource manager 120 for each transactional resource 140. In one embodiment, each of the transaction manager 130 and resource manager 120 may reside on a computing device. These components abstract most of the transaction-specific issues from application components 110, and share the responsibility of implementation of transactions. A transaction resource 140 is a resource of data on which a transaction performs transactional operations. A traditional transactional resource 140 may include components such as a database or a message queue. However, embodiments of the invention implement user-controlled transactional resources 140. The various components of this architecture are discussed in more detail below.

Application components 110 are clients for the transactional resources 140. They are the programs with which the application developer implements business transactions. In one embodiment, the application components 110 may be part of one or more applications that implement business logic. With the help of the transaction manager 130, application components 140 create global transactions, propagate the transaction context if necessary, and operate on the transactional resources 140 within the scope of these transactions. As part of the application logic, application components 110 generally make a decision whether to commit or rollback transactions.

A resource manager 120 is a component that manages transactional resources 140 and participates in the commit and recovery protocols with the transaction manager 130. A resource manager 120 is typically a driver or a wrapper over a transactional resource 140, with interfaces for operating on the data associated with the transactional resource 140 (for the application components) and for participating in the commit and recovery protocols coordinated by a transaction manager 130. A resource manager 120 may also, directly or indirectly, register transactional resources 140 with the transaction manager 130, so that the transaction manager 130 can keep track of all the transactional resources 140 participating in a transaction. This process is called resource enlistment. Resource managers 120 provide two sets of interfaces: one set for the application components 110 to get connections and perform operations on the data of transactional resources 140, and the other set for the transaction manager 130 to participate in the commit and recovery protocol.

The transaction manager 130 is the core component of the transaction processing environment 100. Its primary responsibilities are to create transactions when requested by application components 110, allow resource enlistment and delistment, and to conduct the commit or recovery protocol with the resource managers 120.

A typical transactional application begins a transaction by issuing a request to the transaction manager 130 to initiate a transaction. In response, the transaction manager 130 starts a transaction and associates it with the calling thread of the transactional application. The transaction manager 130 also establishes a transaction context. All application components 110 and/or threads participating in the transaction share the transaction context. The thread that initially issued the request for beginning the transaction, or, if the transaction manager 130 allows, any other thread may eventually terminate the transaction by issuing a commit or rollback request.

Before a transaction is terminated, any number of components and/or threads may perform transactional operations on any number of transactional resources 140 known to the transaction manager 130. If allowed by the transaction manager 130, a transaction may be suspended or resumed before finally completing the transaction. Once the application issues the commit request, the transaction manager 130 prepares all the transactional resources 140 for a commit operation and issues a commit or rollback request to all the transactional resources 140. Which request (i.e., commit or rollback) is issued depends on whether or not all of the transactional resources 140 are ready for the commit.

Embodiments of the invention introduce a user-controlled transactional resource 150. The user in this context is the end-user of the transactional application. A user-controlled transactional resource 150 allows the user to be involved as part of the transaction and makes the user a necessary component in automatically committing or rolling back a transaction. Together with other transactional resources 140, the user-controlled transactional resource 150 can participate in a transaction.

Providing a user-controlled transactional resource 150 requires exposing the user in such a way as to make him or her transactional. In other words, the user-controlled transactional resource 150 should represent a result of contacting a user. This result may include a confirmation of the transaction, an approval of the transaction, a disapproval of the transaction, or no answer by the user. Optionally, the user may be notified about the overall result of the transaction (success or failure) when there are other transactional resources involved in the transaction. This final notification corresponds to the second phase of the transaction where the transaction is either committed or rolled back. In one embodiment, the transaction utilizing the user-controlled transactional resource 150 may contain the necessary logic to contact the user in order to obtain the user result needed for the transaction.

Example cases of utilizing a user-controlled transactional resource 150 include any situation where financial transactions are taking place where a user needs to approve the transaction. Such user approval increases the security of these financial transactions. One example is to confirm purchases from web stores. Another example is the previously-mentioned bank transaction. Embodiments of the invention are not limited solely to financial transactions, but may be expanded to any transaction which requires a user's confirmation or approval.

User-controlled transactional resources 150 represent the result of contacting a user. Embodiments of the invention encompass contacting the user via phone, email, SMS, and/or USSD (texting in GSM) messaging, to name a few examples. In one embodiment, the user's contact information may be obtained from account information associated with the user in the transaction. However, embodiments of the invention envision various means to obtain user contact information and are implementation-specific operations of the specific transaction and user-controlled transactional resource 150.

When utilizing a user-controlled transactional resource 150 in embodiments of the invention, a transaction would prepare the user-controlled transactional resource 150, which results in a contact to the user taking place to obtain confirmation or approval of the transaction. Then, the transaction may continue by executing any other operations in the transaction context until it reaches the end of the transaction boundary, where a commit is called. On commit, the transaction manager 130 ends the transaction and persists all changes. If an exception occurs (e.g., the user does not approve of the transaction or cannot be reached) or all transactional resources 140 are not prepared to commit, then the transaction may end by rolling back all changes made during execution of transaction operations.

Implementing a user-controlled transactional resource 150 entails defining at least three operations on the user-controlled transactional resource 150: prepare, commit, and rollback. For example, in the bank transfer example, the result of contacting the user and the user's bank accounts would all be transactional resources 140, 150 in embodiments of the invention. Each transactional resource 140, 150 has the same three operations defined (i.e., prepare, commit, rollback), as well as other specific operations that, for example, allow subtraction of money, addition of money, and contacting the user (e.g., via phone, email, GSM messaging, USSD messaging, etc.).

Additionally, implementing a user-controlled transactional resource 150 entails providing an interface to the transactional resource 150, so that a resource manager 125 associated with the transactional resource 150 can communicate with it. The interface is a contract between a transactional resource 150 and its associated resource manager 125. The contract specifies what methods are exposed from the transactional resource 150 to the resource manager 125. As previously mentioned, the role of the resource manager 125 is to be aware of the contract. In other words, the resource manager 125 should be aware of what operations the transactional resource 150 it manages is exposing. Embodiments of the invention use this interface in order to expose the user's input via the user-controlled transactional resource 150.

Some embodiments of the invention may be implemented in a JAVA-based transaction processing architecture. In JAVA Enterprise Edition (J2EE), every transactional resource has to implement a JAVA interface. The JAVA transaction initiative consists of two specifications: JAVA Transaction Service (JTS) and JAVA Transaction API (JTA). JTS specifies the implementation of a JAVA transaction manager. This transaction manager supports the JTA, using which application servers can be built to support transactional JAVA applications. Internally, the JTS implements the JAVA mapping of the Object Management Group (OMG) Object Transaction Service (OTS) 1.1 specifications. The JTA specifies a transaction processing architecture for building transactional application servers and defines a set of interfaces for various components of this architecture. The JTS thus provides an architecture for transactional application servers and applications, while complying with the OMG OTS 1.1 interfaces internally.

In the JAVA transaction model, JAVA application components can conduct transactional operations on JTA compliant resources via the JTS. The JTS acts as a layer over the OTS. The applications can therefore initiate global transactions to include other OTS transaction managers, or participate in global transactions initiated by other OTS compliant transaction managers.

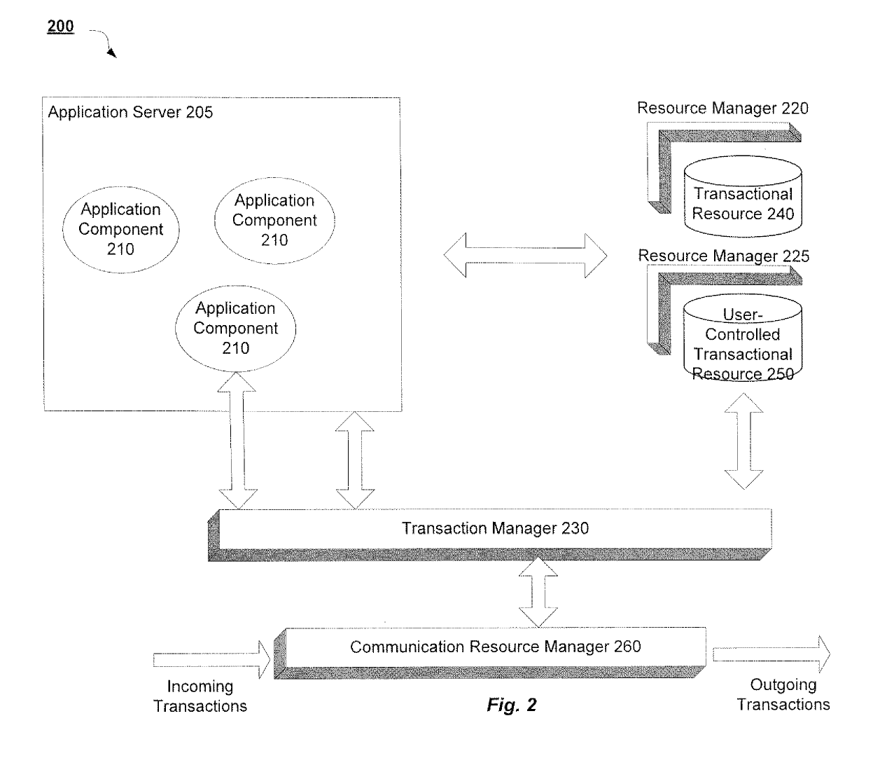

FIG. 2 is a block diagram of a JTS architecture 200 implementing user-controlled transactional resources according to an embodiment of the invention. In one embodiment, the JTS architecture 200 is a JAVA-specific implementation of transaction processing architecture 100 described with respect to FIG. 1. The JTS architecture 200 is architected around an application server 205 and a transaction manager 230.

The JTS architecture 200 includes a transaction manager 230. The transaction manager 230 is the core component of this architecture 200 and is provided by an implementation of the JTS. It provides interfaces to create transactions (including transaction demarcation and propagation of transaction context), allows enlistment and delistment of resources, provides interfaces for registering components for application synchronization, implements the synchronization protocol, and initiates and directs the commit and recovery protocol with the resource managers 220, 225.

One of the key features of the JTS architecture 200 is that it allows an application server 205 to be built on top of the transaction service and the resources. Application developers can develop and deploy application components onto the application server for initiating and managing transactions. The application server 205 can therefore abstract all transactional semantics from the application programs.

A communication resource manager 260 allows the transaction manager 230 to participate in transactions initiated by other transaction managers (not shown). However, the JTS specification does not specify any protocol for this communication and assumes that an implementation of the communication resource manager supports the CORBA OTS and General Inter-ORB Protocol (GIOP) specifications. ORB stands for object request brokers.

The application components 210 are the clients for the transactional resources 240 and implement business transactions. These are deployed on the application server 205. Depending on the architecture of the application server 205, these components 210 can directly or indirectly create transactions and operate on the transactional resources 240, 250. For example, an Enterprise JavaBean (EJB) server allows declarative transaction demarcation, in which case, the EJB components need not directly implement the transactions. However, a JAVA implementation of a CORBA OTS requires the CORBA object to demarcate transactions explicitly.

The resource managers 220, 225 are X/Open XA compliant components that manage transactional resources 240, 250, and participate in the commit and recovery protocol with the transaction manager 230. The resource managers 220, 225 also provide interfaces for the application server 205 and the application components 210 to operate on the transactional resources 240, 250 managed by it. The transactional resources 240, 250 are components upon which the application components 210 operate and perform the transaction. In one embodiment, the user-controlled transactional resource 250 is the same as the user-controlled transactional resource 150 described with respect to FIG. 1.

In the JTS architecture 200, all transactional resources 240, 250 implement the XAResource interface. The JTA specification may be classified into three categories of interfaces. In the JTS architecture 200, these are provided by the transaction manager 230, resource manager 220, 25, and the application components 210. For purposes of the present application, the resource manager 220, 225 interface is now described in more detail for use by user-controlled transactional resources 250 and their associated resource managers 225.

The XAResource interface used between resource managers 220, 225 and their associated transactional resources 240, 250 is javax.transaction.xa.XAResource. This is a JAVA mapping of the X/Open XA interface, and is implemented by resource managers 220, 225 operating with the JTS. This interface provides methods to start (start) and end (end) work on behalf of a specified transaction, to prepare a transaction with the current resource 240, 250 (prepare), to end transactions with the current resource 240, 250 (commit, forget, recover, and rollback), to compare the current resource manager 220, 225 with another resource manager 220, 225 (isSameRM), and to get and set the transaction timeout (getTransactionTimeout, setTransactionTimeout).

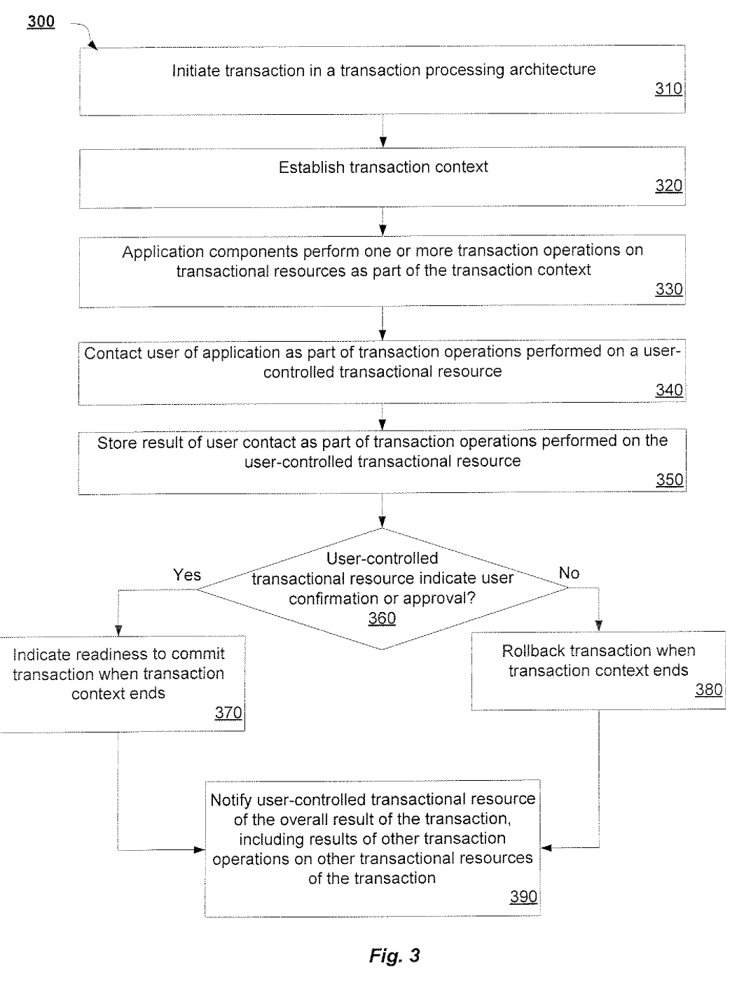

FIG. 3 is a flow diagram illustrating a method 300 for using a user-controlled transactional resource as part of a transaction processing context according to an embodiment of the invention. Method 300 may be performed by processing logic that may comprise hardware (e.g., circuitry, dedicated logic, programmable logic, microcode, etc.), software (such as instructions run on a processing device), or a combination thereof. In one embodiment, method 300 is performed by transaction processing architecture 100 of FIG. 1.

Method 300 begins at block 310 where a transaction that is part of an application program is initiated in a transaction processing architecture. In one embodiment, a transaction manager is responsible for initiating the transaction. Prior to the initiation process, transactional resources of the transaction are allocated by the application itself prior to initiating the transaction. It is responsibility of the application to allocate the resources, start the transaction context and end the transaction context (a.k.a. Transaction demarcation). For example, the following pseudocode illustrates a typical transactional resource allocation procedure:

```
allocate TransactionalResource1
allocate TransactionalResource2
begin transaction
    TransactionalResource1.askForConfirmation( )
    TransactionalResource2.askForConfirmation( )
end transaction
```

In the above example pseudocode, assume that TransactionResource1 and TransactionResource2 are user-managed transactional resources associated with user1 and user2, respectively, participating in the same transaction. The operations between begin and end occur in a single transactional context. As part of the transaction context user1 is asked to confirm and replies OK, and user2 is asked to confirm and replies NO. As a result, the transaction fails. However, user1 must be notified of the outcome (failed) even though he or she has confirmed previously.

Then, at block 320, a transaction context is established. The transaction context tracks the state in which the transaction presently resides. At block 330, application components in the transaction processing architecture perform one or more transaction operations on transactional resources as part of the transaction context.

Subsequently, at block 340, the user is contacted as part of transaction operations performed on a user-controlled transactional resource. The user-controlled transactional resource represents a result of contacting a user, so that the user can be involved as part of the transaction and be a necessary component in automatically committing or rolling back the transaction. At block 350, a result of the user contact is stored by at least one of the user-controlled transactional resource as or the transaction manager part of the operations performed for the transaction. In one embodiment, the user-controlled transactional resource may have memory associated with it in which it can store the user contact results. In one embodiment, the user contact results may include, but are not limited to, confirmation of the transaction, approval of the transaction, disapproval of the transaction, or no answer by the user.

At block 360, the transaction processing architecture determines whether the user-controlled transactional resource indicates a user confirmation or approval of the transaction. If so, then at block 370, the user-controlled transactional resource indicates a readiness to commit the transaction when the transaction context ends. If not, then at block 380, the transaction is rolled back when the transaction context ends, or even possibly at an earlier time in the transaction context. Lastly, at block 390, the user-controlled transactional resource is notified of the overall result of the transaction, including results of other transaction operations on other transactional resources of the transaction. In one embodiment, the transaction manager may perform this notification process.

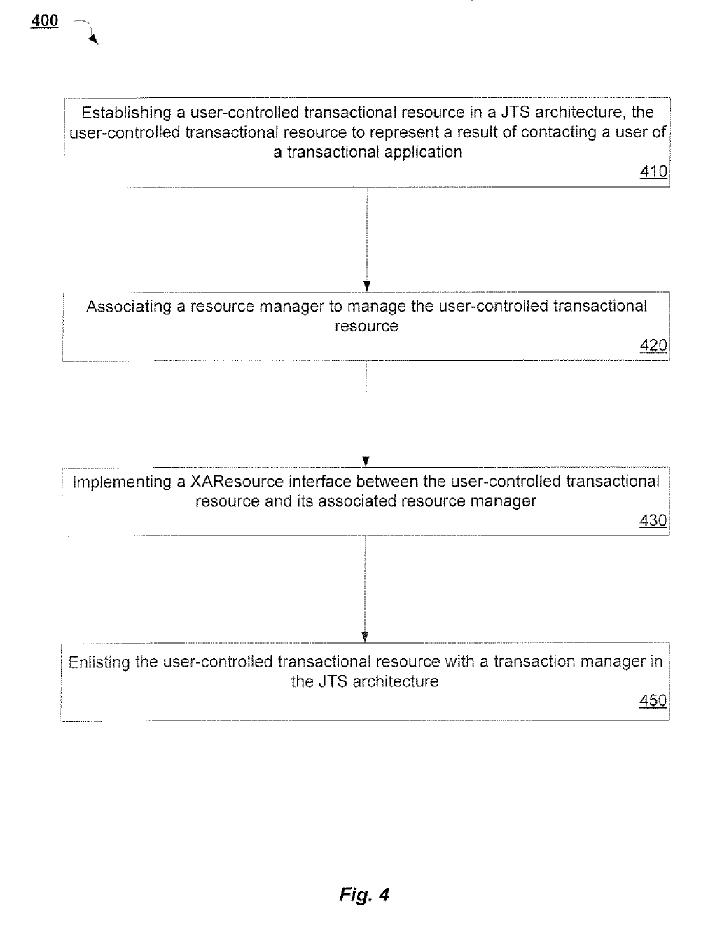

FIG. 4 is a flow diagram illustrating a method 400 for implementing a user-controlled transactional resource in a JAVA environment according to an embodiment of the invention. Method 400 may be performed by processing logic that may comprise hardware (e.g., circuitry, dedicated logic, programmable logic, microcode, etc.), software (such as instructions run on a processing device), or a combination thereof. In one embodiment, method 400 is performed by JTS architecture 200 of FIG. 2.

Method 400 begins at block 410 where a user-controlled transactional resource is established in a JTS architecture. The user-controlled transactional resource represents a result of contacting a user of an application implemented in the transaction processing architecture. Then, at block 420, a resource manager is associated with the user-controlled transactional resource in order to manage the user-controlled transactional resource.

At block 430, XAResource interface is implemented between the user-controlled transactional resource and its associated resource manager. As discussed previously, the XAResource is javax.transaction.xa.XAResource, which is a JAVA mapping of the X/Open XA interface. Lastly, at block 440, the user-controlled transactional resource is enlisted with a transaction manager in the JTS architecture. Enlisting the user-controlled transactional resource allows application components to perform operations on the user-controlled transactional resource as part of transaction processing for one or more transactional applications.

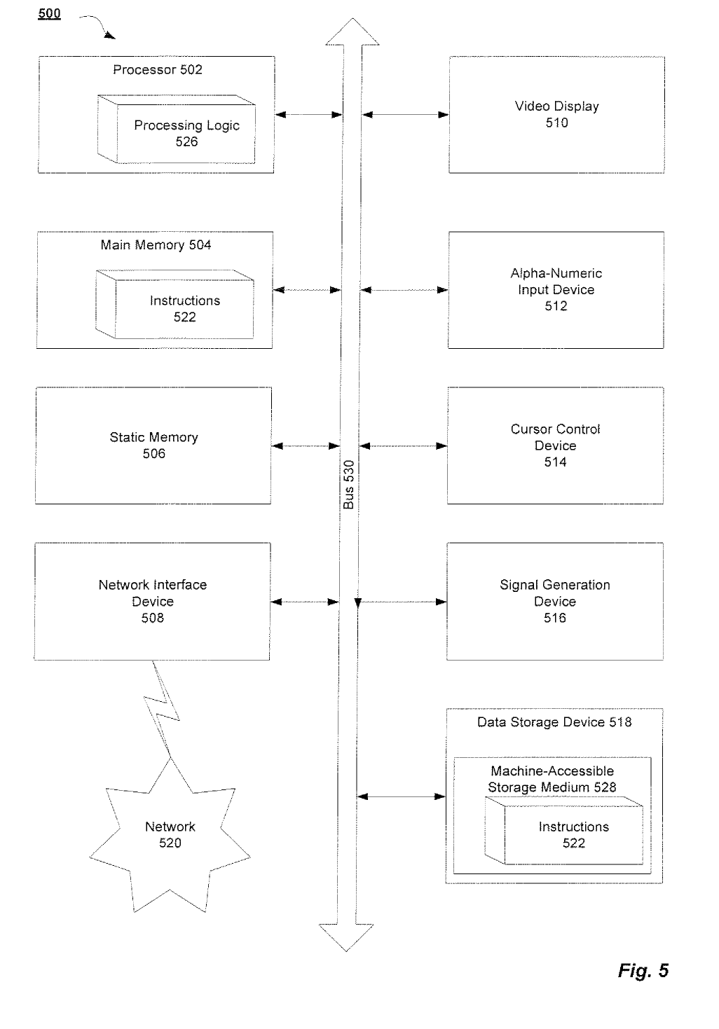

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an internet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium 528 on which is stored one or more set of instructions (e.g., software 522) embodying any one or more of the methodologies of functions described herein. The software 522 may also reside, completely or at least partially, within the main memory 504 and/or within the processing device 502 during execution thereof by the computer system 500; the main memory 504 and the processing device 502 also constituting machine-accessible storage media. The software 522 may further be transmitted or received over a network 520 via the network interface device 508.

The machine-readable storage medium 528 may also be used to stored instructions to perform implementation of user-controlled transactional resources described with respect to FIGS. 3 and 4, and/or a software library containing methods that call the above applications. While the machine-accessible storage medium 528 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method, comprising:
initiating a transaction as part of a transactional application in a transaction processing architecture;
performing one or more transaction operations as part of the transaction on one or more transactional resources of the transaction processing architecture;
contacting a user of the transactional application as one of the transaction operations performed on a user-controlled transactional resource; and
storing a result of contacting the user in at least one of the user-controlled transactional resource or a transaction manager overseeing the transaction.

2. The method of claim 1, wherein a result of contacting the user includes at least one of a confirmation of the transaction, an approval of the transaction, a disapproval of the transaction, and no answer by the user.

3. The method of claim 2, wherein if the user-controlled transaction resource does indicate at least one of a user confirmation or approval, indicating by the user-controlled transactional resource a readiness to commit the transaction when the transaction ends.

4. The method of claim 3, wherein if the user-controlled transaction resource does not indicate at least one of a user confirmation or approval, rolling back the transaction when the transaction ends.

5. The method of claim 1, further comprising notifying the user of the overall result of the transaction including results of one or more other transactional resource operations.

6. The method of claim 1, wherein contacting the user may include utilizing at least one of a telephone, an email, a text message, an SMS message, and a USSD message.

7. The method of claim 1, wherein the transaction processing architecture is implemented as a JAVA transaction service (JTS) supporting a JAVA Transaction API (JTA).

8. The method of claim 7, wherein the user-controlled transactional resource and a resource manager associated with the user-controller transaction resource implement a XAResource interface to communicate.

9. A system, comprising:
a memory;
a processor communicably coupled to the memory; and
a transaction processing architecture that utilizes resources of the processor and the memory, the transaction processing architecture operable to:
initiate a transaction as part of a transactional application;
perform one or more transaction operations on one or more transactional resources as part of the transaction;
contact a user of the transactional application as one of the transaction operations performed on a user-controlled transactional; and
store a result of contacting the user in at least one of the user-controlled transactional resource or a transaction manager overseeing the transaction.

10. The system of claim 9, wherein a result of contacting the user includes at least one of a confirmation of the transaction, an approval of the transaction, a disapproval of the transaction, and no answer by the user.

11. The system of claim 10, wherein:
if the user-controlled transaction resource does indicate at least one of a user confirmation or approval, indicating by the user-controlled transactional resource a readiness to commit the transaction when the transaction ends; and
otherwise if the user-controlled transaction resource does not indicate at least one of a user confirmation or approval, rolling back the transaction when the transaction ends.

12. The system of claim 9, wherein the transaction processing architecture further operable to notify the user of the overall result of the transaction including results of one or more other transactional resource operations.

13. The system of claim 9, wherein contacting the user may include utilizing at least one of a telephone, an email, a text message, an SMS message, and a USSD message.

14. The system of claim 9, wherein the transaction processing architecture is implemented as a JAVA transaction service (JTS) supporting a JAVA Transaction API (JTA).

15. The system of claim 9, wherein the user-controlled transactional resource and a resource manager associated with the user-controller transaction resource implement a XAResource interface to communicate.

16. An article of manufacture comprising a machine-readable storage medium including data that, when accessed by a machine, cause the machine to perform operations comprising:
initiating a transaction as part of a transactional application in a transaction processing architecture;
performing one or more transaction operations as part of the transaction on one or more transactional resources of the transaction processing architecture;
contacting a user of the transactional application as one of the transaction operations performed on a user-controlled transactional resource; and
storing a result of contacting the user in at least one of the user-controlled transactional resource or a transaction manager overseeing the transaction.

17. The article of manufacture of claim 16, wherein a result of contacting the user includes at least one of a confirmation of the transaction, an approval of the transaction, a disapproval of the transaction, and no answer by the user.

18. The article of manufacture of claim 17, wherein the data, when accessed by the machine, causes the machine to perform further operations comprising:
determining whether the user-controlled transactional resource indicates at least one of a user confirmation or approval; and
if the user-controlled transaction resource does indicate at least one of a user confirmation or approval, indicating by the user-controlled transactional resource a readiness to commit the transaction when the transaction ends; and
if the user-controlled transaction resource does not indicate at least one of a user confirmation or approval, rolling back the transaction when the transaction ends.

19. The article of manufacture of claim 16, wherein contacting the user may include utilizing at least one of a telephone, an email, a text message, an SMS message, and a USSD message.

20. The article of manufacture of claim 16, wherein the transaction processing architecture is implemented as a JAVA transaction service (JTS) supporting a JAVA Transaction API (JTA), and the user-controlled transactional resource and a resource manager associated with the user-controller transaction resource implement a XAResource interface to communicate.
